(19) United States
(12) Patent Application Publication
(10) Pub. No.: US 2026/0321139 A1
(43) Pub. Date: Oct. 15, 2026

(54) DRIVE ASSISTANCE SYSTEM FOR AN AUTONOMOUS DRIVING VEHICLE AND ASSISTANCE METHOD THEREOF

(71) Applicant: MOVYON S.P.A., Roma (IT)

(72) Inventors: Mattia BRAMBILLA, Roma (IT); Benedetto CARAMBIA, Roma (IT); Diego FRANCESCHINI, Roma (IT); Monica Barbara NICOLI, Roma (IT)

(21) Appl. No.: 19/485,444

(22) PCT Filed: May 15, 2024
(86) PCT No.: PCT/IB2024/054705

§ 371 Date: Nov. 18, 2025

(30) Foreign Application Priority Data
May 19, 2023 (IT) 102023000010158

(51) Int. Cl. G08G 1/0967; H04W 4/40

(52) U.S. Cl. CPC G08G 1/096783; G08G 1/096741; H04W 4/40

(57) ABSTRACT

A drive assistance method and system for a vehicle equipped with an assisted driving control unit is disclosed, wherein the system comprises mobile position sensors on-board of the vehicle, one or more fixed radio communication units (RSUs), located in the vicinity of a road network, capable of communicating with at least one on-board vehicle radio transceiver unit (OBU) configured to transfer data to/from a respective vehicle control unit, one or more fixed environmental sensors configured to detect extended position data of vehicles in the vicinity, logical storage media storing accurate position information of such fixed communication units (RSUs) and fixed environmental sensors, and also includes requesting assistance means on board a requesting vehicle which, when said vehicle control unit detects degraded conditions of said mobile position sensors, activates an uplink radio transmission containing an assistance request signal addressed to said fixed communication units (RSUs), a co-ordination unit of a road operator equipped with a processing capability capable of extracting position parameters of said requesting vehicle from said uplink radio transmission containing a request for assistance signal received on a plurality of said fixed communication units (RSUs) and extracting extended position data of the requesting vehicle from signals detected by said fixed environmental sensors, and wherein said position parameters and extended position data of the requesting vehicle are aggregated by that coordinating unit and transmitted back to that transceiver unit (OBU) as feedback data via a downlink message.

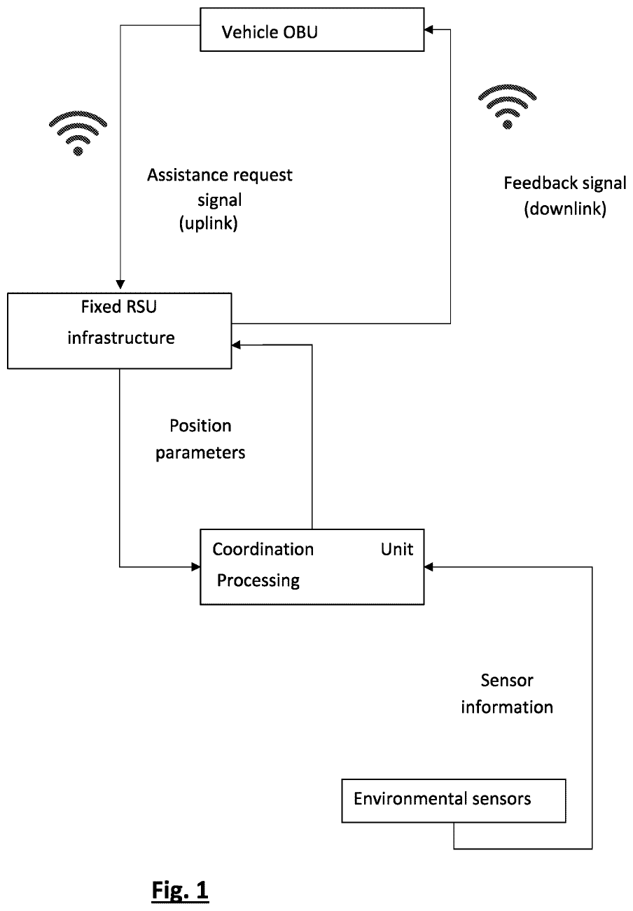

### FIELD OF THE INVENTION

The present invention relates to an assistance system for a self-driving vehicle and an assistance method thereof. In particular, the proposed system provides assistance information to the self-driving vehicle to ensure that it operates as safely and efficiently as possible when the vehicle is moving on public roads. The system is based on a road infrastructure equipped with wireless or radio communication technology (in the remainder of the text these two terms will be used as synonyms) and managed by a road operator, capable of exchanging bi-directional signals with the vehicle itself.

### BACKGROUND ART

The rapid increase in the number of road vehicles has amplified problems such as pollution, congestion and accidents. Self-driving vehicles are now seen as a potential solution to these problems.

The self-driving vehicle refers to all vehicles-including, but not limited to, motor vehicles, motorbikes, tractors, heavy goods vehicles, and any other type of vehicle moving on the road—capable of moving on the traditional road network using a multiplicity of on-board sensors (such as GNSS receivers, radar, lidar, IMU, cameras, etc.) that detect boundary conditions and allow a special control unit to perform the driving function autonomously instead of a human driver (who is left with only the function of supervision and, possibly, route setting).

The control unit, however, is not always able to properly manage the driving of the vehicle, in all conditions and locations. Unforeseen or unpredictable traffic situations, or complex boundary conditions such as, but not limited to, adverse weather, degraded pavement conditions, temporary road construction sites or degraded satellite coverage, can affect the reliability, robustness and accuracy of the on-board sensors to the point where the control unit does not have sufficient or reliable information and is unable to drive the vehicle safely.

In fact, the traditional road network represents a very complex environment (for example winding roads, tunnels, viaducts, crossings of uninhabited areas, etc.), which has not been specifically designed to facilitate autonomous driving of a vehicle; hence the nature and limited number of sensors on board the vehicle do not always allow for robust, reliable and accurate data to be provided.

The main limitation is that the sensors on board the vehicle are typically capable of collecting data of local relevance (belonging to the parameters of the vehicle itself) or in the proximity of the vehicle itself (within a radius of a few tens of metres at most). In the absence of a communication system that provides extended, i.e. ‘non-visible’ and ‘non-detectable’ information to/from the sensors available on board the vehicle itself, the vehicle is not always able to have the information necessary for driving and/or to know about the presence of potential hazards in the vicinity (outside the detection range of its on-board sensors).

According to the prior art, infrastructure solutions have already been offered that vehicles can connect to in order to obtain additional information and thus improve their perception of their surroundings. Some of these solutions are disclosed in US 2023/0018419, U.S. Pat. No. 10,928,834, CN 115,240,453, U.S. Pat. No. 11,232,709, US 2021/0024095, U.S. Pat. No. 11,334,090.

To date, however, connected vehicles, and more generally the systems for C-ITS Day 1.0 and Day 1.5 services (connections with V2X technologies and, specifically, V2I and V2V), while being able to receive extended information in order to increase driving safety (warning function), are not able to enable autonomous driving in all conditions and locations (SAE level 5). The ‘awareness’ messages are in fact conceived as perception information to be provided to the vehicle to enhance its vision capacity but not to correct its behaviour in real time. V2I and V2V communications, already used in some of the solutions presented above, make a vehicle potentially aware of the state of the environment, infrastructure and/or other surrounding vehicles but are not able to implement control logic on the vehicle. For example, the C-ITS ‘Road Works Warning’ service alerts the vehicle to the existence of a potential hazard along the route, at a specific point; however, it is not used by the vehicle to replace its on-board systems, nor to implement control logic.

The architecture of an autonomous driving vehicle comprises five interacting functional units: localisation, perception, planning, control and system management. These five units cooperate with each other to answer three questions: “Where is the vehicle?”, “What is around it?” and “What is the next move?”. Vehicle localisation, in particular, identifies the position of the vehicle in a global co-ordinate system (geographic co-ordinate system): in order to make correct driving decisions, perception, planning and control require a very accurate knowledge of the position of the vehicle as well as any dangerous objects or situations near it. Localisation is therefore a key prerogative as the first building block of the functional architecture of an autonomous driving vehicle.

For an autonomous vehicle to operate safely and effectively, it is essential that the localisation unit can be accurate, robust and reliable, able to function in all weather, urban and mobility conditions.

The position of a given object (static or in motion) therefore represents crucial information in the field of mobility: most services related to road safety and efficiency are based on this type of information (e.g.: navigation systems, satellite tolling, in-vehicle eCall services, management of private and/or public transport fleets, etc.).

Today, there are numerous localisation services that rely on different technologies and positioning techniques. The dominant technology in mobility and transport is satellite navigation, which is achieved through the use of in-vehicle devices capable of decoding signals sent by orbiting satellites. One example is the GPS (Global Positioning System) positioning system. GPS, through a dedicated network of orbiting artificial satellites, provides a mobile terminal (GPS receiver) with information on its position, speed and time (PVT), ideally anywhere (in practice only where GPS coverage is available) on Earth or in its immediate vicinity, provided there is a connection to at least four of the system's satellites. Localisation takes place by means of the transmission of a radio signal by each satellite and the reception and subsequent processing of the same signals by the receiver device on board the vehicle, based on the spherical positioning method (or multilateration). The system made available for civil use by the US government (Standard Positioning System, or SPS) achieves an accuracy in the order of a few metres, which can, however, reach tens of metres in the case of poor satellite visibility or in environments characterised by multiple reflections of the received signal. Besides GPS, other global navigation satellite systems or GNSS (Global Navigation Satellite System) are available today (or being developed/modernised), including the Russian Global Navigation Satellite System (or GLONASS), the European GALILEO and the Chinese BeiDou.

In general, GNSS cannot guarantee the levels of accuracy, reliability, and robustness required by autonomous navigation systems, due to effects in radio signal propagation, such as signal blockage and multiple paths, which are more or less pronounced depending on site conditions and which prevent total reliance on them for the development of autonomous navigation algorithms.

In particular, all these systems are characterised by a degradation of performance, in terms of accuracy and reliability, when deviating from the so-called ‘open sky’ condition. Positioning accuracy basically depends on two factors: the geometric factor (i.e. the relative position between the satellites in visibility and the target whose position is to be estimated), and the accuracy of the measurement extracted from the signals received from the satellites (User Equivalent Range Error, UERE), the latter being affected by various sources of error such as thermal/electronic noise and interference, multi-path phenomena due to signal blocking (Non-Line of Sight, or NLOS) and multiple reflections, atmospheric effects of the ionosphere and troposphere, synchronisation errors of satellite and receiver clocks, and so on.

Accurate (with an accuracy in the order of 30 cm or even better) and continuous localisation of the vehicle is a needed prerequisite for advanced assisted/autonomous driving services, which include, for example, cooperative systems for the control of complex manoeuvres such as overtaking and lane-entering, for active safety (anti-collision), for remote driving and platooning. The complexity of a road and motorway network, with the presence of bridges, viaducts, tunnels and complex multi-level junctions, can degrade the performance of a satellite positioning system to such an extent that it cannot guarantee the use of these services along the entire length of a route.

While the accuracy of satellite measurement can be increased through systems such as Differential GPS (DGPS), Assisted GPS (AGPS) or the Real Time Kinematic technique (GPS RTK), the availability of satellites in coverage is highly dependent on maintaining the open-sky condition, which cannot always be guaranteed along a road network (not in tunnels, for example). Thus, DGPS, AGPS and GPS-RTK are methods that improve the accuracy of conventional GPS—GPS-RTK, which achieves centimetre accuracies, is considered the Gold Standard as a localisation system for autonomous driving—but still suffer from poor reliability and robustness, and above all do not work in closed areas such as tunnels and galleries.

In these situations, V2V and V2I communication systems can act as ‘augmentation’ systems, providing the vehicle with more positioning information than just the on-board sensors. By receiving additional information, e.g. from the road infrastructure, the vehicle is able to supplement the data collected by its sensors and improve the accuracy, robustness and reliability of localisation under different driving and environmental conditions.

In particular, a road infrastructure made up of RSUs (Road Side Units) equipped with wireless communication technology can be used to communicate with vehicles in transit and provide location services to vehicles connected to it via an OBU (On Board Unit). Regardless of the specific configuration or whether or not a standard exists for RSUs or OBUs, it is understood that the units thus identified are part of the background of a skilled in the field, who possesses a common general knowledge that RSUs are generically communication units located at the roadside for exchanging data with vehicles in the vicinity, while OBUs are communication devices on board a vehicle that are capable of communicating data with other OBUs or RSUs. The complexity, development, redundancy and advanced technology available along the road infrastructure can be harnessed to deliver vehicle location services to the vehicle itself, with sub-metric accuracy enabling the vehicle to meet the requirements of autonomous mobility services and continue its assisted/autonomous navigation in a ‘seamless’ manner—even when the operating conditions of on-board sensors are compromised by environmental factors.

US2020/77238 describes an infrastructure comprising a plurality of RSUs capable of communicating messages with an OBU in a vehicle. This document teaches how to determine the position of a vehicle on the basis of a double exchange of messages between OBUs and RSUs, outward and return. The absolute position of the RSUs must be known and transmitted in the return message to the OBU, so that the multi-lateration calculations necessary to determine the position with respect to the RSU network can be performed in the vehicle. With this solution, the messages contain a large amount of data and the calculation engine for determining the position is placed on board the vehicle. It is envisaged that the positioning engine can be placed in the infrastructure, but it is not explained how this can be configured, and, in addition, the extraction of distance measurements requires a downlink transmission (from the infrastructure to the vehicle). In an additional embodiment, it is expected that there are also other parameters available for position calculation, e.g. a street angle, which are broadcast by the RSUs.

Other techniques for communication between vehicles and fixed stations are described in US2023/15003 and in the articles by Kuutti Sampo et al. ‘A Survey of the State-of-the-Art Lococalisation Techniques and Their Potentials for Autonomous Vehicle Applications’, IEEE INTERNET OF THINGS JOURNAL, IEEE, USA, vol. 5, no. 2, 1 Apr. 2018.

### SUMMARY OF THE INVENTION

The purpose of the present invention is to provide a vehicle assistance system and a related assistance method to optimise the operation of self-driving vehicles under conditions where on-board location sensors experience degraded operation.

This is achieved by means of a system having the essential features described in the appended main claims. Other preferred features of the invention are defined in the dependent claims.

At the base of the teaching provided here, it is envisaged that one or more vehicles are autonomously navigating along portions of road (whether urban or motorway, or any other denomination) covered by a communication infrastructure, equipped with RSUs with wireless communication, managed by a roadside operator. Given the possible criticality of the reliability of its on-board sensors, the vehicle may find itself in situations where it is no longer able to navigate autonomously in safety, requiring manual driving or a stop at the roadside, thus posing a danger to road safety. To avoid these unfortunate dangerous situations, according to the invention the control unit of the vehicle itself is configured in such a way that it can request assistance from the infrastructure of the road operator (by sending messages with V2X communication technology), which can use its own technology installed along the roadside to assist the navigation of the vehicle requesting assistance.

The road infrastructure comprises a number of sensors available to the road operator, including, for example, video cameras, radars, inductive loops, antennas, optical barriers, etc. from which it is possible to extract and combine information regarding the positioning of passing vehicles and, in particular, the vehicle requiring assistance. The vehicle positioning information, once received by the multiplicity of sensors and combined with each other, is sent in aggregate form to the vehicle via V2X communications, so that the vehicle control unit can quickly use it for its own positioning and subsequent guidance functions.

In addition to the sensors available to the infrastructure, it is also possible to use the same radio signal transmitted via V2X technology, containing the message sent by the vehicle requesting assistance to the RSU infrastructure (uplink signal), to locate the vehicle itself. Specifically, the signal containing the message requesting assistance is received by one or more RSUs—via V2X communication—and can be used to calculate the position of the vehicle by means of radio-localisation and tracking techniques, appropriately using the parameters of the radio signal and converting them into relative position information (position of the OBU with respect to the RSU). To this end, RSUs in the network may or may not be synchronised depending on the type of parameters used for tracking purposes.

Examples of parameters that can be detected by up-link transmission and converted into position information include Time Of Flight (TOF), Time Difference of Arrival (TDOA), Angle of Arrival (AOA), Angle of Departure (AOD), Round Trip Time (RTT), Received Signal Strength (RSS). The use of the above measurements can allow the road infrastructure equipped with RSUs to estimate the position of an OBU terminal on board the vehicle requesting assistance in relation to the positions of the installed RSUs (the positions of the latter being known precisely following an accurate measurement of the positions upon installation).

The position estimate of the OBU of the vehicle requesting assistance, calculated by the infrastructure in which the RSUs are networked, is then transmitted back (downlink) to the OBU terminal of the vehicle, which uses it to determine or improve the accuracy of its own coordinates that are useful for the vehicle's driving logic.

Such a V2X-based communication system therefore offers the following advantages:
1. High accuracy, due to the fixed (and precisely known) position of the RSUS placed with a geometric configuration (deployment) optimised for localisation;
2. High reliability, through the guarantee of a fixed number of RSUs in the transmission range achieved through optimised deployment.

The system according to the invention therefore provides for the installation of one or more Road Side Units (RSUs) operated by a road operator and the installation of one or more additional sensors, also operated by the road operator, which monitor an area of interest. The road operator sets up a coordination unit that uses the information received from such sensors, to monitor the conditions of the areas of interest (e.g. all of its own road sections or only the most critical ones) and, if a vehicle requests assistance for assisted/autonomous driving purposes through radio interaction with the RSUs, the coordination unit is able to process—through aggregation/combination of the available information—an accurate location of such vehicle and send it back (downlink) to the vehicle itself, with appropriate spatial reference system, by means of V2X communication technology.

The self-driving vehicle, when experiencing degradation of the information available from its on-board sensors, instead of requesting driver intervention or even interrupting its navigation due to the unreliability of the position information from its on-board sensors, requests assistance from the road infrastructure and uses the position data it receives to undertake driving manoeuvres (lane changes, accelerations, braking, etc.) to complement or replace the position information it obtains from its on-board sensors (e.g. GPS). The information exchanged thus goes beyond the simple awareness of classic C-ITS services.

The fixed infrastructure of the road operator is capable of providing adequate information to ‘guide’ the vehicle, should the vehicle require such assistance, especially when the vehicle's on-board sensors are inoperative or unable to provide reliable data. The role of the infrastructure is especially crucial when the vehicle technologically prepared to offer an autonomous driving service is suddenly faced with unforeseen or rare situations of malfunctioning or shutdown of its on-board sensors: in these cases, the vehicle, instead of forcing a return to ‘manual’ driving (if any), can rely on the location information provided by the road infrastructure itself.

### BRIEF DESCRIPTION OF THE DRAWINGS

Further features and advantages of the invention will, however, be best illustrated by the following detailed description of a preferred embodiment, given by way of example and not limitation and illustrated in the accompanying drawing, which represents a flow chart schematising the interaction between the components envisaged in the system according to the invention.

### DETAILED DESCRIPTION OF THE INVENTION

The object of the invention is a system comprising a road infrastructure for the provision of location data for a high-precision radio location service to support the on-board control unit of an autonomous driving vehicle.

An autonomous driving vehicle, in this context, is defined as a vehicle of any kind that has signal processing capability for signals from on-board sensors, capable of determining drive commands to the moving members (engine, brakes, steering, . . . ) that either guide the vehicle completely autonomously or assist driving by a human driver. In this sense, the terms autonomous driving or assisted driving are to be understood as synonymous.

In the context of this description, the term “vehicle” means a mechanical vehicle equipped with its own engine, intended for road transport of persons or goods, having two or more wheels, and driven by a natural person driver or, in the case of autonomous driving, by a driving controller. On board the vehicle, according to the present invention, one or more communication devices (e.g., On-Board Units—OBUs with Dedicated Short Range Communication technology—DSRCs) capable of sending/receiving signals to and from an external prospective infrastructure are provided.

The system includes
one or more communication units known as Road Side Units (RSUs), forming part of a road infrastructure and located in the vicinity of a road (of any type and classification: motorway, suburban, urban, paved or unpaved, public or private), equipped with short/medium-range radio communication technology to communicate with an appropriate radio transceiver unit (OBU) installed on board a vehicle in transit or parked in the vicinity,
one or more environmental sensors of a different nature, such as video cameras, radar, inductive loops, antennas for various frequencies and signals, optical barriers, etc., capable of detecting various parameters associated with a passing vehicle.

The present invention is not limited to the use of a specific technology, which means that there are no limits on the characteristics of the communication (e.g. frequency, bandwidth, modulation, etc.), protocols and/or standards used.

Cellular technology (4G, 5G and evolutions), Wi-Fi, Ultra-Wide Band and the like can be used for radio communication between RSUs and vehicle transceivers.

An RSU is a radio module equipped with an antenna, used within fixed road infrastructure, that enables bi-directional communication between infrastructure and vehicle: it functions as both transmitter and receiver. The RSU may also be able to process data and communicate with a traffic control centre via communication interfaces such as, but not limited to, Ethernet, LTE, 5G, etc.

RSUs must be installed on appropriate supports such as, but not limited to, variable message signs, poles, brackets, and others that may be available along the operator's road network.

The RSUs must have characteristics that ensure maximum performance under all environmental conditions (IP rating and appropriate operating temperature range).

The functionality of the RSUs communication units provides for the sending and receiving of radio signals to/from the OBU communication devices of a vehicle in transit on the roadway, or parked in or near it. The dual send/receive functionality allows a two-way connection to be established between RSUs and OBUs. Communication from the vehicle OBU to the RSU is conventionally referred to as uplink, while communication in reverse is referred to as downlink.

The individual RSU communication units and the multiple sensors arranged along the road network are managed by a road operator's coordination unit, which is set up to collect heterogeneous data from the environmental sensors and the RSUs themselves, combine them and return at least the aggregated location data of a requesting vehicle, which is then transferred to the vehicle itself when it is in transit (or parked) in the vicinity of relevant RSUs.

The aggregation of several types of data concerning the same vehicle enables the road operator to locate the vehicle with greater reliability and accuracy. Likewise, the aggregation and fusion of data at a road operator's co-ordination unit enables a synthetic description of the vehicle itself and its location. This synthetic information is then shared with the requesting vehicle connected and transiting (or parked) in the vicinity of relevant RSUs.

Such data aggregation methods for reducing the use of available bandwidth include, but are not limited to, algorithms that analyse the positioning data from the RSUs and environmental sensors in order to return a weighted average positioning data to the vehicle based on the confidence of the individual position data arriving at the coordination unit from the RSUs and environmental sensors.

The use of radio signals for communication between RSUs and OBUs also enables them to be used for localisation purposes of the connected vehicles: it is possible to exploit the characteristics of the hardware in transmission and reception to conveniently extract parameters from the uplink radio signal, coming from the OBUs, to be used for localising the vehicles themselves, as will be better explained further on.

Vehicle localisation is the main application purpose of the teaching provided herein: with the system according to the invention, a road operator is able to provide a localisation service to vehicles connected to relevant RSUs via the vehicles' OBUs, preferably in combination with one or more sensors of another type managed by the road operator. To this end, the accurate geographic position (understood, for example, as absolute geographic coordinates in three dimensions or as relative positioning with respect to a precisely identified road section) of the RSUs is preliminarily determined and stored in an appropriate logical storage medium (e.g. a local memory of the RSU or a global database for a plurality of RSUs) accessible from the coordination unit. Similarly, the position of the other environmental sensors must also be determined with high accuracy and stored in a similar logical storage medium.

To summarise, in the system according to the invention, precise geolocation data from environmental sensors and fixed RSU stations that are networked with the same coordination unit of the road operator are determined and stored in appropriate databases (single or distributed) for further processing (with the purpose of providing the location information to a requesting vehicle).

Accurate positioning can be achieved manually with special measuring systems, or through £ self-calibration procedures exploiting the radio connection between neighbouring RSUs (e.g. during installation).

According to the invention, in addition to data from environmental sensors, location data of a requesting vehicle is obtained by extrapolating at least one required position parameter from the uplink radio communication signal between the requesting vehicle's OBU and the respective RSUs under coverage.

When the control unit of a vehicle detects that its on-board sensors are providing degraded position information—i.e. it receives positioning information from its on-board sensors that are deemed inadequate to continue driving safely—it triggers assistance request means to send a radio transmission containing an assistance request signal addressed to proximity RSUs.

The requesting vehicle begins transmitting assistance requests to the proximity RSUs if the vehicle's control unit detects that the on-board sensors are providing degraded position information that could jeopardise the safety of driving in autonomous mode. These radio signals are generated by the vehicle and sent with a frequency (understood as the number of messages per second sent by the vehicle to the RSUs) suitable for the purpose of localisation and compatible, therefore, with the typical speeds of a road vehicle, depending on the environment (urban road, motorway, etc.) within which it is located. The number and location of RSUs along the road network are optimised in such a way as to preferably have at least 3 RSUs in coverage with respect to any position the vehicle may take when travelling within road sections equipped with such a system.

The uplink message transmitted by the vehicle is detected by a plurality of RSUs, which use the radio signal to determine the position of the transmitting OBU of the vehicle requesting assistance using various available techniques.

Operationally, the system control process takes place in this sequence:
1—A vehicle logic unit detects a degraded position information condition and requests assistance
2—One or more RSUs receive the assistance request and notify the coordination unit
3—The coordination unit identifies the area where the vehicle requiring assistance is located and ‘triggers’ the heterogeneous sensors located there
4—Sensors and RSUs collect environmental and communication data and communicate them to the co-ordination unit
5—The coordination unit aggregates and makes a fusion of these heterogeneous data
6—The coordination unit sends aggregated synthetic position data of the assistance requesting vehicle to the RSUs in the vicinity of the vehicle
7—The RSUs send position information to the vehicle itself, which is used by the on-board controls for autonomous navigation.

An example of a more detailed logic diagram of this process is given below:
1. A control unit, with processing capability, on board the self-driving or autonomous vehicle detects that the position information available on board is not sufficiently accurate.
2. The control unit on board the self-driving vehicle composes a message containing information on the potential anomaly/position non-accuracy condition and sends it to one or more V2X communication devices available on board the vehicle, typically one or more OBUs (integrated or separate from the control unit).
3. One or more V2X communication unit(s) on board the self-driving vehicle sends (in broadcast or other mode) a dedicated request message containing information on the potential anomaly/position non-accuracy condition or inserts this information inside other types of V2X messages.
4. One or more antenna of a road operator's RSUs equipped with a V2X communication system receive the request message sent by the self-driving vehicle.
5. A processing unit within or near each RSUs decodes the message and communicates to the co-ordination unit the request for vehicle assistance; at the same time it also sends to the co-ordination unit parameters detected by the radio transmission that are suitable to contribute to the location of the vehicle, e.g. TOA, TDOA, AOA and AOD extracted from the uplink radio signals (as further specified below).
6. The coordination unit receives one or more messages from the RSUs and processing units activates one or more environmental sensors (lidar, radar, camera, etc.) in the vicinity of the self-driving vehicle requesting assistance or, if the sensors are in continuous real-time data collection mode, identifies the sensors located in the vicinity of the vehicle.
7. The road operator's environmental sensors located in the vicinity of the vehicle requesting assistance send information signals so as to provide one or more parameters to help locate the vehicle. The information is aggregated and processed by the co-ordination unit.
8. The coordination unit estimates the position the vehicle requesting assistance by merging one or more pieces of information provided by the environmental sensors and RSUs operated by the road operator and located in the vicinity of the vehicle requesting assistance.

The coordination unit sends the vehicle position information (understood as absolute position together with the relative uncertainty data) to the RSUs located in the vicinity of the vehicle (the RSUs to which the vehicle may be connected).
10. The processing units associated with the RSUs receive the vehicle position information and compose a dedicated message containing the location information and send it (downlink) to the vehicle OBU via V2X technology (in broadcast, unicast or other mode).
11. One or more V2X communication apparatuses available on board the self-driving vehicle that requested assistance receive the message coming from one or more RSUs, send it to its processing unit that decodes it and returns position information to the vehicle that will possibly be used for autonomous navigation purposes to complete or replace what has already been collected by the sensors available on board the vehicle.

As detailed above, one or more RSUs in proximity to the requesting vehicle receives the assistance request signal and transmits it to the co-ordination unit for processing, so as to extract both indications on the assistance request and parameters related to the same radio communication (on which the assistance request message travels) that allow other intrinsic information on the positioning of the vehicle to be obtained.

In the event that distance measurements for determining position are based on signal transfer times (e.g. TOF or TDOA), the RSUs must be temporally synchronised with each other. This ensures that TOF and/or TDOA measurements can only be traced back to distances and/or differences in distances between RSUs and OBUS and are not affected by errors due to misalignment between time references to different RSUs (present when the network of tracking devices is not synchronous). The synchronisation technology itself is known and independent of what is described in this specification, and may consider wired or wireless connection solutions between RSUs.

In fact, irrespective of the available hardware, the system according to the invention preferably also uses one or more of the following measurements extracted from the radio signal used for communication between the V2X communication apparatus on board the vehicle and the RSU(s) as a location parameter:
time of flight (TOF)
Time Difference of Arrival (TDOA)
round trip time (RTT)
Angles of Arrival (AOA)
Angles of Departure (AOD)
Received Signal Strength (RSS).

In the system according to the invention, the coordination unit has a processing logic in which the above-mentioned measurements are used as location parameters and processed appropriately to provide a position of the requesting vehicle. In particular, the coordination unit uses appropriate calculation algorithms—operating in one or more processors belonging to the road operator—which may use a series of homogeneous measurements (of the same type, e.g. AOA only) or also heterogeneous measurements (e.g. TOD+AOA, TDOA+AOD) from one or more RSUs. Such algorithms can also be run on a cloud platform.

The integration of one or more measurements from one or more RSUs is subsequently used by the co-ordination unit to estimate the precise position of the vehicle. With this position estimation, the co-ordination unit can enable drive assistance services by arranging and sending, via the RSUs, an appropriate downlink feedback signal comprising extended location information and/or drive information (understood as information intended to indicate to the vehicle processing unit which commands to execute, e.g. to pull over in a parking area) to the requesting vehicle.

As mentioned above, the integration of measurements obtained from the communication signal with RSUs can also include vehicle position information obtained through other heterogeneous environmental sensors, such as cameras, radar, inductive loops, antennas, etc.

The aggregation of data coming from heterogeneous sensors implies the presence of ‘sensor fusion’ algorithms (based on statistical, deterministic approaches, or in general on artificial intelligence methods) that are able to receive heterogeneous inputs, fuse them correctly and produce a single output of vehicle position (and relative confidence). In fact, it is appropriate to communicate to the vehicle not only the position intended as a vector of spatial coordinates in 3 dimensions, but it is also necessary to provide an aggregate confidence information of this estimated position (i.e. variance of the estimate). In fact, the main purpose of sensor fusion algorithms is to increase the confidence in the position estimate, or, to put it another way, to reduce the uncertainty associated with the estimate. The use of different sensors, each with its own degree of uncertainty and field of view and perspective, makes it possible to integrate the various information referring to the position of the vehicle and the relative spatial uncertainties, and to produce an output data characterised by a joint optimisation of the fields of view and a combination of the various pieces of information appropriately weighted.

Examples of sensor fusion algorithms that receive information from multiple sensors include Bayesian filters (such as Kalman filter, extended Kalman filter, Unscented Kalman filter, particle filter, belief propagation, etc.) or machine learning approaches based on neural networks operating on ‘time series’ of any architecture (feedforward neural network, convolutional neural network, recurrent neural network, transformer, Bayesian neural network, etc.), intersection or covariance union methods, least squares methods, etc. . . . .

The feedback signal relayed by the RSU(s) to the OBU of the requesting vehicle may simply contain extended position information, which the vehicle control unit uses to enhance or replace the position information obtained from the on-board sensors and continue its assisted driving logic.

Alternatively or additionally, the feedback signal relayed back to the requesting vehicle's OBU may contain guidance information, e.g. indications to drive the vehicle to a certain desired position, which take into account the conformation of the nearby road network or any existing services (parking area, shelter area, electric recharging zone, sos pillar, . . . ), thus providing an additional service to the autonomous driving capability that the control unit on board the vehicle would have.

If the vehicle receiving the position estimation information from the road operator has no other measurements to use (e.g. its GPS system is not functioning at the moment, because it is out of order or because there is no coverage), it may request and use the operator's position estimation as its exclusive position information (the vehicle's position estimation is exclusively estimated by the road operator); if, on the other hand, it has other sensors available, it may consider the information received from the road operator at its own discretion, increasing (or not) the measurements that can be used to estimate its position. In this second case, the road operator's role is to provide a non-exclusive position estimate, leaving the vehicle to use it.

The sensors on board of the vehicle do not belong to the road operator, but can benefit from the vehicle position estimation information provided by the road operator to update/adjust/correct its position estimation.

The fact that it is a road operator who provides the location information, also represents a guarantee for the driver of the vehicle, because the information is provided by a responsible party who, above all, possesses all appropriate and up-to-date road infrastructure references. According to a preferred variant of the system according to the invention, the feedback data, transmitted by means of a downlink message and containing said position parameters and extended position data of the requesting vehicle, also contains certification data (digital certificate) interpretable by said vehicle control unit. The position data received by the control unit are thus only considered trustworthy and used to control the vehicle if the certification data are recognised as belonging to a party considered trustworthy (typically the road operator).

It is understood, however, that the invention is not to be considered limited to the particular arrangements illustrated above, which are only an exemplary embodiment of it, but that several variants are possible, all within the reach of a person skilled in the art, without thereby going beyond the scope of protection of the invention itself, as defined by the following claims.

For example, the proposed system can also be extended to the localisation not only of vehicles but also of other types of users such as pedestrians (e.g. operators on motorway construction sites), provided they are equipped with a radio unit (User Equipment UE) that performs the functions of the OBU mentioned above.

Again, it can be envisaged that the vehicle control unit will detect degraded conditions of these mobile location sensors either autonomously, or at the anticipated prompting of the road infrastructure itself, when the vehicle is detected in the vicinity of an area known to have poor positioning signal coverage, or where there is a need to increase positioning accuracy (e. g. near a road construction site). In such a case, the RSUs themselves can transmit warning signals to the vehicle's OBU, signals that are interpreted as an invitation to the detection of degraded conditions and thus to the activation of the transmission of the assistance request signal addressed to these fixed communication units (RSUs).

1. Drive assistance system for a vehicle equipped with an assisted driving control unit, comprising
mobile position sensors on-board of the vehicle,
one or more fixed radio communication units (RSUs), located in the vicinity of a road network, capable of communicating with at least one on-board vehicle radio transceiver unit (OBU) configured to transfer data to/from a respective vehicle control unit,
one or more fixed environmental sensors configured to detect extended position data of vehicles in the vicinity,
logical storage media storing accurate position information of such fixed communication units (RSUs) and fixed environmental sensors,
characterised in that it also includes
requesting assistance means on board a requesting vehicle that, when said vehicle control unit detects degraded conditions of said mobile position sensors, activates an uplink radio transmission containing an assistance request signal addressed to said fixed communication units (RSUs),
a co-ordination unit of a road operator equipped with a processing capability capable of extracting position parameters of said requesting vehicle from said uplink radio transmission containing a request for assistance signal received on a plurality of said fixed communication units (RSUs) and extracting extended position data of the requesting vehicle from signals detected by said fixed environmental sensors,
and wherein said position parameters and extended position data of the requesting vehicle are aggregated by that coordinating unit and transmitted back to that transceiver unit (OBU) as feedback data via a downlink message.

2. Drive assistance system as in claim 1, wherein said feedback data contains position information of said requesting vehicle.

3. Drive assistance system as in claim 1, wherein said feedback data contains guidance information.

4. Drive assistance system as in claim 1 wherein said at least one on-board vehicle radio transceiver unit (OBU) comprises a processing unit and a V2X transmission unit.

5. Drive assistance system as in claim 1, wherein said position parameters are determined by one or more measurements obtained from said uplink radio transmission between:
time of flight (TOF)
Time Difference of Arrival (TDOA)
round trip time (RTT)
Angles of Arrival (AOA)
Angles of Departure (AOD)
Received Signal Strength (RSS).

6. Assistance drive system as in claim 1, wherein said position parameters are determined by one or more measurements obtained from said uplink radio transmission between:
time of flight (TOF)
Time Difference of Arrival (TDOA)
round trip time (RTT)
and wherein said fixed radio communication units (RSUs) are temporally synchronised with each other.

7. A method of assisting a vehicle equipped with an assisted driving control unit comprising a system as in claim 1, wherein
one or more fixed environmental sensors are configured to detect extended position data of vehicles in close proximity, characterised by that
when a control unit of a requesting vehicle detects degraded conditions of mobile position sensors in the vehicle, it triggers assistance requesting means on board of the vehicle so that
a mobile radio transceiver unit on board a requesting vehicle (OBU), configured to transfer data to/from said respective vehicle control unit, emits an uplink radio transmission containing an assistance request signal addressed to fixed communication units (RSUs) located in the vicinity of a road network, and
a coordination unit of a road operator with processing capacity extracts
position parameters of said requesting vehicle from said uplink radio transmission containing an assistance request signal, and
extended position data of the requesting vehicle detected by these fixed environmental sensors
and in which said position parameters and extended position data of the requesting vehicle are integrated by said coordinating unit and transmitted back to said mobile radio transceiver unit (OBU) as feedback data with a downlink radio transmission.

8. Method of assisting a vehicle as in claim 7, wherein
said control unit on board the requesting vehicle composes a request message containing information relating to said degraded conditions and transmits it to said assistance requesting means, in the form of V2X communication equipment,
said V2X communication equipment communicates said assistance request message to at least one fixed radio communication unit (RSU) equipped with a V2X communication system,
a processing unit associated with said fixed radio communication units (RSUs) decodes said request message and communicates said vehicle assistance request to that coordination unit of road operator,
said coordination unit detects signals containing said extended position data from one or more fixed environmental sensors in the vicinity of said requesting vehicle, then aggregates and processes said extended position data to determine a position estimate for the requesting vehicle,
said coordination unit sends said position estimate to said at least one fixed communication unit (RSU) located in the vicinity of the requesting vehicle, which composes a message containing said feedback data including said position estimate and sends it to said mobile radio transceiver unit (OBU) via V2X technology.

9. Method of assisting a vehicle as in claim 8, wherein
said processing unit associated with said fixed communication units (RSUs) also transmit to said coordination unit said position parameters detected by said uplink radio transmission such as:
time of flight (TOF)
Time Difference of Arrival (TDOA)
round trip time (RTT)
Angles of Arrival (AOA)
Angles of Departure (AOD)
Received Signal Strength (RSS).

10. Method of assisting a vehicle as in claim 7, wherein
said vehicle control unit is prompted to detect said degraded conditions by a transmission of a warning signal from a fixed communication unit (RSU) to said mobile radio transceiver unit (OBU) via V2X technology.
